(19) United States
(12) Patent Application Publication
(10) Pub. No.: US 2016/0081369 A1
(43) Pub. Date: Mar. 24, 2016

(54) METHODS OF PREPARING MORE DIGESTIBLE ANIMAL FEED

(71) Applicant: Archer Daniels Midland Company, Decatur, IL (US)

(72) Inventors: Charles Abbas, Champaign, IL (US); Wu-Li Bao, Champaign, IL (US); Kyle Beery, Decatur, IL (US); Michael J. Cecava, Decatur, IN (US); Perry H. Doane, Decatur, IN (US); James L. Dunn, Decatur, IN (US); David P. Holzgraefe, Quincy, IL (US)

(73) Assignee: Archer Daniels Midland Company

(21) Appl. No.: 14/959,747

(22) Filed: Dec. 4, 2015

Related U.S. Application Data
(63) Continuation of application No. 12/042,452, filed on Mar. 5, 2008, now abandoned.
(60) Provisional application No. 60/904,938, filed on Mar. 5, 2007.

(51) Int. Cl. A23K 1/165; A23K 1/18

(52) U.S. Cl. CPC A23K 1/1656; A23K 1/1813; A23K 1/1833

(57) ABSTRACT

Disclosed herein are methods of treating an edible fiber source to make an animal feed with increased digestible energy. An exemplary method includes hydrolyzing the edible fiber source with an inorganic fiber hydrolyzing agent in a twin screw mixer that shears the edible fiber to a size of between 0.5 to 25 mm. The hydrolysis in the mixer occurs at pressure of about 14 psig or higher with a temperature about 100° C. to 110° C. The inorganic hydrolysis liberates a first portion of soluble carbohydrates from the edible fiber source. The inorganically hydrolyzed material is also treated (before or after) with a fiber degrading enzyme to solubilize a second portion of carbohydrates. The dually hydrolyzed material is dried to form an animal feed or feed ingredient having a soluble and insoluble carbohydrate fraction with the amount of soluble carbohydrate being at least 45% wt/wt of the total carbohydrates obtained from the edible fiber source.

### CROSS-REFERENCE TO RELATED APPLICATIONS

This application is a continuation of U.S. application Ser. No. 12/042,452, filed Mar. 5, 2008, which itself claims priority to U.S. Provisional Application No. 60/904,938 filed Mar. 5, 2007, each of the contents of the entirety of which are incorporated herein by reference in their entirety.

### FIELD OF THE INVENTION

This disclosure is directed to animal feeds, particularly to animal feeds made from the by-products of agricultural processing, and more particularly to methods of increasing the digestibility of edible fibers in such by-products for use as animal feeds for ruminants and monogastrics

### BACKGROUND

The following includes information that may be useful in understanding the present teaching. It is not an admission that any of the information provided herein is prior art, or material, to the presently described or claimed disclosures, or that any publication or document that is specifically or implicitly referenced is prior art.

Approximately ten billion bushels of corn are harvested annually in the United States. Of this quantity, approximately 6.0 billion bushels of corn are utilized as an animal feed, with 1.5 billion bushels of that being utilized as a cattle feed and an additional 0.7 billion bushels being utilized as a feed for dairy cattle. Of the remaining quantity, approximately 3.0 billion bushels are processed by wet or dry milling, with over 1.6 billion bushels being processed for ethanol production.

The use of bio-based transportation fuels (i.e., ethanol) in the United States will need to increase from 1.0 percent of U.S. transportation fuel consumption in 2005 to 4 percent of transportation fuel consumption in 2010 and further to 10 percent in 2020 and 20 percent in 2030, according to the Roadmap for Biomass Technology in the United States (“Roadmap for Biomass Technologies in the United States.” DOE/Biomass Research and Development Technical Advisory Committee, Biomass Research and Development Initiative-7219. US Department of Energy, Washington, D.C., December 2002). For this to occur, the use of renewable carbohydrates for fuel ethanol must increase dramatically, possibly by the increased use of corn as an ethanol feedstock, specifically by dry milling. Dry milling of corn is currently the most cost effective way to produce ethanol from corn, but produces the fewest number of co-products.

Corn is fed to cattle to provide an inexpensive energy and protein source. The starch in corn is readily metabolized in the rumen by the rumen microorganisms. These microorganisms ferment the starch to organic acids, which can cause acidosis in the cattle, and the energy from the starch generally goes to bacterial growth. If this corn were to be diverted to produce ethanol by dry milling, an additional 5.75 billion gallons of ethanol could be produced. Based on a production of 3.41 billion gallons of ethanol in 2004, this would increase the total ethanol production nearly four-fold without increasing corn acreage planted. By diverting this corn from cattle feed to ethanol production, two issues will arise. The first issue is the loss of energy from starch for cattle feed, and the second is the additional production of corn dry milling byproducts, which will greatly over-saturate the animal feed market. There is a need therefore, to find ways to improve dry milling by-products and otherwise find ways of making enhanced cattle feed from low starch materials to replace the energy from starch.

To replace the estimated 2.2 billion bushels of corn currently utilized annually as a dairy and beef cattle feed, an equivalent amount of bio-available feed would need to be substituted for the corn. 2.3 billion bushels of corn are equivalent to 112.7 billion pounds total, comprising approximately 83.7 billion pounds of starch, and 13.2 billion pounds of lignocellulosics. By the current dry milling process, 2.3 billion bushels of corn would yield 39.1 billion pounds of distillers dried grains (DDG) and distillers dried grains with solubles (DDGS), which are the major by-products of the dry-milling process. Therefore, an additional 73.6 billion pounds of bio-available feed would need to be made up by currently available lignocellulosics, such as soybeans hulls, corn stover, or wheat straw. The energy content of the feed-stocks would also need to be determined to ensure an equivalent amount of feed energy value for the new bio-available cattle feed.

Cattle are able to utilize the protein from DDG and DDGS in their diet. The cellulose and hemi cellulose are broken down enzymatically in the rumen of the animal as a source of mono- and disaccharides. The DDGS also contain vitamins and minerals that are beneficial to animals such as cattle. However, there remains potentially digestible fiber content in these materials (and other fiber containing bi-products of agricultural processing) that is inaccessible to the animal due to the partially insolubility and crystalline nature of such materials.

There is therefore, a need in the art to enable the expansion of ethanol production by corn dry-milling while ensuring adequate feed supply to the cattle market, and a more general need to find methods of improving the by-products of agricultural processing for use as animal feeds.

### BRIEF SUMMARY

The present disclosure is based on the discovery that the fiber-containing by-products from agricultural processing can be treated by various techniques to increase the digestibility of lignocellulosics and other fiber containing materials present in such fiber sources, in order to improve the usefulness of such fiber containing materials as animal feeds for ruminants and monogastric animals.

In one aspect there is disclosed a process for making an animal feed that includes contacting an edible fiber source in a mixture with an inorganic fiber hydrolyzing agent at a pressure of at least 10 psig and a temperature of at least 75° C. for a time sufficient to solubilize at least 10% of carbohydrates from lignocellulosic material in the edible fiber source. The contacted edible fiber source is dried to form a dried mixture having an insoluble fiber fraction and a soluble carbohydrate fraction derived from a common edible fiber source. In a typical practice, the mixture inclusive of the edible fiber source has a moisture content of 40% or less during the contacting. In an exemplary embodiment, the moisture content is about 35%. In a typical embodiment of the dried mixture, the percentage of soluble carbohydrates is at least 45% wt/wt of the total carbohydrates contributed by the insoluble fiber fraction and soluble carbohydrate fraction.

The process can be conducted in batch or continuous modes. In a batch mode, contacting the edible fiber source with the inorganic fiber hydrolyzing agent occurs in a pressure vessel and the pressure is about 16 psig to about 60 psig, the temperature is about 121° C. to 150° C., and the time is between about 10 minutes to about 60 minutes. In an advantageous continuous process, contacting the edible fiber source with the inorganic fiber hydrolyzing agent occurs in a mixing device having at least one rotating member that shears the edible fiber and the pressure is about 14 psig to about 50 psig, more typically about 14 psig to about 25 psig, the temperature is about 75° C. to 110° C., or more typically about 100° C. to 105° C. and the time is between about 1 second to less than 5 minutes. In advantageous embodiments, contacting the edible fiber source with an inorganic hydrolyzing agent occurs in a twin-shaft, co-rotating mixer that shears the edible fiber simultaneously with the contacting. In a typical practice, treating in the co-rotating extruder is under conditions sufficient to shear the insoluble fibers in the edible fiber source to obtain fiber particles having a mean length of about 0.5 to about 25 mm, or more preferably about 3 mm to about 5 mm, or typically about 4 mm in the longest dimension. In the most advantageous embodiments where a twin screw extruder is used as the mixing device, the contacting can be as short as about 4 to 5 seconds.

In another advantageous embodiment, the edible fiber is also contacted with at least one enzyme fiber hydrolyzing agent from a class selected from the group consisting of cellulases, hemicellulases, esterases phtyases, laccases, peroxidases and proteases for time sufficient to also solubilize carbohydrates from the edible fiber source prior to drying. Contacting with the enzyme can occur before, after or simultaneously with the contacting with the inorganic fiber hydrolyzing agent. In a typical practice, the edible fiber source is contacted with the enzyme at a temperature of at least 50° C. Alternative temperatures for contacting can range from 20° C. to about 80° C. The pH of the of the material during contacting with the enzyme should range from about 2 to about 7, with more optimal pH's being in the range of about 4 to 6. Accordingly, in embodiments where the enzyme is used simultaneously with the inorganic fiber hydrolyzing agent, the hydrolyzing agent should be one that is acidic to neutral, other wise the contacting with the enzyme should prefer before or after contacting with the inorganic agent with appropriate pH adjustment to optimize the fiber degrading activity of the enzyme.

The inorganic fiber hydrolyzing agent can be at least one agent selected from the group consisting of a pH modifying agent and an oxidizing agent. In typical embodiments, the inorganic fiber hydrolyzing agent is selected from the group consisting of calcium oxide, sodium hydroxide potassium hydroxide, hypochlorite, ammonia, and a peroxide. It has been discovered that calcium oxide is most suitable as an inorganic fiber hydrolyzing agent, but that calcium oxide also inhibits the activity of the fiber hydrolyzing enzymes. Accordingly, there is a proviso that if the edible fiber source is contacted with the inorganic fiber hydrolyzing agent prior or simultaneously with contacting with the enzyme, the inorganic fiber hydrolyzing agent should not be calcium oxide. Also, when the inorganic fiber hydrolyzing agent includes a peroxide, a peroxidase is advantageously used as the fiber degrading enzyme.

In a similar process described in U.S. Pat. No. 4,965,086 ammonia and hydrogen peroxide were used to hydrolyze lignocellulosic material, but not under the pressure and temperature conditions described herein. The use of both ammonia and peroxide was required in the process described in the '086 patent to obtain the best hydrolysis. It has been surprisingly discovered in the present invention, that peroxide is not needed with ammonia when the temperature and pressures are elevated Accordingly one distinguishing embodiment of the present disclosure is the proviso that if ammonia is used as the inorganic hydrolyzing agent, hydrogen peroxide is not also used.

In a typical practice, the edible fiber source includes at least one member selected from a the group consisting of switch grass, corn fiber, soy fiber, soy hulls, cocoa hulls, corn cobs, corn husks, corn stove, wheat straw, wheat chaff, distiller dried grains, distillers dried grains with solubles, barley straw, rice straw, flax hulls, soy meal, corn meal, wheat germ, corn germ, shrubs, grasses or mixtures of the same. Certain embodiments further include mixing a supplemental feed ingredient with the contacted edible fiber mixture prior to, or subsequent to, drying the mixture to improve the nutritional quality of the feed. The supplemental feed ingredient can be supplied by a material selected from the group consisting of, corn steep liquor, vegetable/plant-based soap stocks, condensed distillers' solubles, molasses, corn syrup, fermentation solubles, fermentation liquors, fermentation liquor distillates, amino acids, glycerin, fats, oils, and lecithin. These material can dry or in liquid form and dried with the mixture of insoluble and soluble carbohydrates formed by the fiber hydrolysis step or steps.

In a similar but second aspect, there is disclosed a process for making an animal feed that includes contacting an edible fiber source in a mixture with an inorganic fiber hydrolyzing agent at a pressure greater than 0 psig and a temperature greater than 25° C. for a time sufficient to solubilize a first portion of carbohydrates from lignocellulosic material in the edible fiber source; also contacting the edible fiber source with an enzyme fiber degrading agent selected from the group consisting of cellulases, hemicellulases, esterases phytases, lacccases, peroxidases and proteases for a time sufficient to solubilize a second portion of carbohydrates from lignocellulosic material in the edible fiber source; and also drying the contacted edible fiber source to form a dried mixture having an insoluble fiber fraction and a soluble carbohydrate fraction derived from a common edible fiber source. This combined process that necessarily uses both the enzyme and inorganic fiber hydrolyzing agents is advantageous in that it can also work without requiring the higher temperatures and pressures. Again, in typical embodiments, the percentage of soluble carbohydrates in the dried mixture is at least 45% wt/wt of the total carbohydrates contributed by the insoluble fiber fraction and soluble carbohydrate fraction.

In similar embodiments as described herein before, the edible fiber can first contacted with the inorganic fiber hydrolyzing agent and then contacted with the enzyme fiber hydrolyzing agent. Alternatively, the edible fiber can first be contacted with the enzyme fiber hydrolyzing agent and then contacted with the inorganic fiber hydrolyzing agent. And advantageously, at lower temperatures of about 50 to 80° C. the edible fiber can be simultaneously contacted with the enzyme fiber hydrolyzing agent and the inorganic fiber hydrolyzing agent.

Similarly under this aspect, in certain embodiments the insoluble fiber fraction is in the form of particles having a mean particle length of about 0.5 to about 25, or more preferably to about 3 mm to 5 mm, typically about 4 mm in its longest dimension. Also in certain embodiments under this aspect, contacting with inorganic fiber hydrolyzing occurs in a mixture having a total moisture content inclusive of the edible fiber content of less than 40% wt/wt. Similarly under this aspect, the inorganic fiber hydrolyzing agent can be at least one agent selected from the group consisting of a pH modifying agent and an oxidizing agent. Again typically, the inorganic fiber hydrolyzing agent is selected from the group consisting of calcium oxide, sodium hydroxide potassium hydroxide, hypochlorite, ammonia, and a peroxide, with the proviso that if the edible fiber source is contacted with the inorganic fiber hydrolyzing agent prior to contacting with the enzyme, the inorganic fiber hydrolyzing agent is not calcium oxide. Also under this aspect is the proviso that if ammonia is used, hydrogen peroxide is not also used. Calcium oxide is a preferred inorganic hydrolyzing agent.

In yet another combinatorial aspect, there is described a process for making an animal feed comprising: contacting an edible fiber source in a mixture with an inorganic fiber hydrolyzing agent in a continuous process in a mixing device having at least one rotating member that shears the edible fiber and wherein the pressure is about 14 psig or higher, the temperature is about 100° C. to 110° C., typically about 100° C. to about 105° C. and the time is between about 1 second to less than 5 minutes to solubilize a first portion of carbohydrates from lignocellulosic material in the edible fiber source; also contacting the edible fiber source with an enzyme fiber degrading agent selected from the group consisting of cellulases, hemicellulases, esterases, phytases, lacccases, peroxidases and proteases for a time sufficient to solubilize a second portion of carbohydrates from lignocellulosic material in the edible fiber source; and also drying the contacted edible fiber source to form a dried mixture having an insoluble fiber fraction and a soluble carbohydrate fraction derived from a common edible fiber source and wherein the soluble carbohydrate fraction is at least 45% wt/wt of the total carbohydrates contributed by the insoluble fiber fraction and soluble carbohydrate fraction.

This third aspect also includes embodiments similar to the others, for example, wherein the insoluble fiber fraction are sheared into particles having a mean particle length of about 0.5 to about 5 mm or more preferably to about 4 mm its longest dimension. In certain embodiments, the edible fiber is first contacted with the inorganic fiber hydrolyzing agent and then contacted with the enzyme fiber hydrolyzing agent. In other embodiments, the edible fiber is first contacted with the enzyme fiber hydrolyzing agent and then contacted with the inorganic fiber hydrolyzing agent. In general embodiments, the inorganic fiber hydrolyzing agent is at least one agent selected from the group consisting of a pH modifying agent and an oxidizing agent. In more specific embodiments, the inorganic fiber hydrolyzing agent is selected from the group consisting of calcium oxide, sodium hydroxide potassium hydroxide, hypochlorite, ammonia, and a peroxide, with the proviso that if the edible fiber source is contacted with the inorganic fiber hydrolyzing agent prior to contacting with the enzyme, the inorganic fiber hydrolyzing agent is not calcium oxide. In certain particular embodiments there is the proviso that if ammonia is used, hydrogen peroxide is not also used, and if hydrogen peroxide is used, the fiber degrading enzyme may include a peroxidase.

In a fourth, but dissimilar aspect, there is also described a process for making an animal feed with increased bulk density comprising: contacting an edible fiber source in a mixture with an inorganic fiber hydrolyzing agent at a pressure of at least 10 psig and a temperature of at least 100° C. for a time sufficient to solubilize at least 45% of carbohydrates from lignocellulosic material in the edible fiber source; dewatering the contacted mixture to separate a portion of soluble carbohydrates from an insoluble fiber fraction; extracting the insoluble fiber fraction with ethanol to dehydrate and increase the bulk density of the insoluble fiber fraction; and drying the insoluble fiber fraction to provide an edible fiber source having increased bulk density.

This aspect provides another method of making a feed after solubilizing a portion of carbohydrate from edible fiber. Certain embodiments further include combining the separated portion of soluble carbohydrates with the dehydrated insoluble fiber fraction and drying the combined material to form a dried mixture having an insoluble fiber fraction and a soluble carbohydrate fraction derived from a common edible fiber source. Other embodiments further include mixing a supplemental feed ingredient with the insoluble fiber fraction prior to drying. Thus, both aspects use the treated edible fiber depleted of a portion of carbohydrates and dehydrated as base material to add back appropriate nutrients, whether it's the solubilized carbohydrate fraction from the hydrolysis, a different nutrient fraction, or both.

In a final aspect, there is disclosed an animal feed made by the processes described herein. Such animal feeds comprise a dried mixture of an insoluble fiber fraction and a soluble carbohydrate fraction derived from the same edible fiber source and optionally intermixed with supplemental feed ingredient to provide nutrition, dietary fiber and higher metabolizable energy to the animal than by simple feeding the untreated edible fiber source. In certain embodiments, the treated and dried edible fiber source can be used alone as a finished feed product. In a typical embodiment, the insoluble fibers in the feed are 0.5 to 25 mm, or more preferably about 3 mm to about 4 mm in length, and the feed contains at least 45% of soluble carbohydrates as percentage of the total carbohydrates in the soluble and insoluble fiber fractions. Another characteristic of certain embodiments is that the animal feed includes an added fiber hydrolyzing enzyme.

### DETAILED DESCRIPTION

### Definitions

Prior to describing the present invention in detail, certain terms that have plain meanings generally understood by those of ordinary skill in the art are nevertheless defined herein to better distinguish nuances in meaning intended by the inventors. It is understood that the definitions provided herein are intended to encompass the ordinary meaning understood in the art without limitation, unless such a meaning would be incompatible with the definitions provided herein, in which case the provided definitions control.

“Edible fiber” means a naturally occurring substance from a plant or microbial source that is comprised predominantly of a carbohydrate polymer and that may be fed to an animal without causing sickness, which is not digestible by humans and is at least partially digestible by most monogastric and ruminant animals. Non limiting examples of edible fibers include celluloses, hemicelluloses, pectins, proteoglycans and the like.

“Edible fiber source” means a material obtained from a plant or microbial source and that contains edible fibers. Practical, but not limiting examples of edible fiber sources include, the hulls of agricultural seed products such as from soy beans, or from grains such as rice, wheat, corn, barley; the stalks from such grains (straw); vegetable/plant-based soap stocks, corn stover, which typically includes the stalks, husks and leaves from a harvested corn plant; processed component fractions of agricultural products that are enriched in fiber, for example corn gluten feed; leaf material from any plant source, and distillers dried grains with or without solubles dried thereon.

“Inorganic fiber hydrolyzing agent” is an inorganic chemical that catalyzes or causes the hydrolysis of glycoside, amide, or acyl bonds in an edible fiber.

“Fiber degrading enzyme agent “means one or more enzymes that catalyses hydrolysis of glycoside, amide, or acyl bonds in an edible fiber.

“About” when used with reference to a numerical expression, means the greater of: (1) the degree of error of a typical instrument or process used to measure the items referenced by the expression; (2) plus or minus 10% of the stated value; or (3) with respect to a range, near enough to the minima or maxima of the range so as not to have any noticeable difference in form or function in comparison to an element exactly at the stated minima or maxima.

“Soluble carbohydrate fraction derived from the edible fiber” means the carbohydrate containing products released from contacting an edible fiber with a thermal, inorganic, enzymatic or physical hydrolyzing agent, which products will more readily dissolve in an aqueous solution after being released from the edible fiber than if the edible fiber were not so contacted.

“Insoluble fiber fraction”: As one of ordinary skill in the art will appreciate, edible fibers integrated within an edible fiber source are only partially soluble in aqueous solutions. That is, while portions of the edible fiber within the edible fiber source are solvated so that they are accessible by enzymes, ions and other solutes, the whole of the edible fiber source does not completely dissolve into the aqueous solution. Accordingly, that portion of the fiber that remains integrated with the edible fiber source and does not completely dissolve in an aqueous solution before and after treatment with a fiber degrading agent is the “insoluble fiber fraction”.

“Dry” or “Dried” means a material has a moisture content of less than 15% wt/wt, or has been treated to reduce the moisture content of the material to less than 50% the moisture content of the same material not so treated.

“Animal Feed”, or simply “feed” refers to a manufactured product specifically used for providing nutritional content to non-human animals by oral administration, in contrast to “food,” which is specifically used for providing nutritional content to humans.

### DESCRIPTION OF DRAWINGS

FIG. 1 is a schematic for comparison of enzyme digestibility and in vitro rumen simulation digestibility for corn stover.

FIG. 2 is a schematic for comparison of enzyme digestibility and in vitro rumen simulation digestibility for wheat straw

### DESCRIPTION OF EXEMPLARY EMBODIMENTS

The teachings of this disclosure are concerned with providing a pretreated and enzyme hydrolyzed biomass fiber feed for animals. Described herein are methods to maintain cattle feed supplies by treating various biomass fiber sources, particularly those that are the by-products of agricultural processing, to improve their digestibility for ruminants, and in certain embodiments, to provide a dried feed pellet as a replacement for corn pellets, distillers dried grain pellets and the like. A further application of the teaching provides animal feed products for use in non-ruminants, including swine and poultry.

Various prior art methods describe pretreating a biomass of fiber containing materials for the purpose of using the materials in human food products. In other teachings of the prior art, pretreated fibers are completely enzymatically hydrolyzed and used for fermentation of the released sugars to various biochemical products. For instance, U.S. Pat. No. 5,693,296 describes the use of Calcium oxide (CaO) under many conditions. However the process of U.S. Pat. No. 5,693,296 is extremely time consuming with residence times often exceeding over one hour. In contrast, the processes described herein use a considerably shorter time for pretreatment of the fiber containing materials thus providing a novel method for increasing the rate of the pretreatment reaction.

In the batch processes described herein that are conducted in a closed pressure vessel with a low moisture content mixture (typically about 30-40%, more typically about 35% moisture) the inorganic hydrolysis can be completed in about 10 to about 60 minutes yielding at least 45% solubilizaation of carbohydrates. The batch process in a closed pressure vessel is typically conducted at temperature of 121° C. to about 150° C. with a pressure of about 10 to about 60 psig., typically at least about 16 psig In the batch process, the starting material is typically sheared to particles with fibers having an average dimension of about 0.5 mm to 25 mm prior to the heat and pressure treatment.

In a better continuous processes described herein, which is conducted in a twin screw type mixer typically (also known as a “continuous processor.”, the temperature in the mixer typically reaches to the range of at least 75° C. to about 110° C., more typically about 100° C. to about 105° C. and the pressure is in the range of about 14 psig to 50 psig. The twin screw mixer typically has at least two rotating members (sometimes referred to as paddles) helically arranged along twin rotating shafts within a barrel. There is a marginal clearance between and paddles and barrel wall, facilitating a shearing action on the material while the helical arrangement urges the material continuously from an inlet to an outlet region. Optionally, the outlet end may be configured with an end plate having pores of various configurations allowing the emerging material to be shaped into a uniform cross sectional bead containing the soluble carbohydrate fraction entwined with the insoluble fiber fraction. In this case, the twin screw mixer can also provide the function of an extruder.

The extruded mixture can be dried and milled into pellets of a uniform size. Supplemental nutrients may be introduced into the twin screw mixer to enhance the feed quality of the final pellet.

The twin screw mixer used for this purpose may have a horizontal, jacketed chamber having two shafts with elliptical paddles such as the Readco Continuous Processor available from READCO KURIMOTO, LLC. (York, Pa.). A more-detailed description of the Readco TFC can be found in DuRoss, U.S. Pat. No. 5,158,789, which is incorporated herein by reference. The Readco processor is a double shaft mixer, which exerts mechanical shear on the material processed, leading to increased temperatures. The shear imparted by the turning paddles of the Readco promotes hydrolysis and enhances digestibility of the plant material being processed The material in the apparatus is at least partially confined in volume so that the shearing force applied to the material leads to an increase in temperature and pressure applied to the material during processing. In one particular embodiment, a Readco apparatus includes a double shafted screw without a pressure plate for extruding the material from the apparatus.

While a Readco type twin screw mixing apparatus is ideal for the present disclosure, the teaching provided herein can be adapted for use in other mixing equipments or with conventional extruders. In other embodiments, a single- or double-shafted extruder may be used with or without a pressure plate. The operation of the extruder may be achieved by those skilled in the art for optimum hydrolysis of the fiber.

One advantage of using the a Readco type twin screw mixer is that the starting fiber material is simultaneously solubilized and sheared into particles with fibers having an average particle size of about 0.5 mm to 25 mm, and more typically about 3-5 mm (4 mm on average). Again, the moisture content of the fiber material is less typically less than 40%. Another advantage is that the simultaneous mixing and shearing occurs within a small volume within the twin shafted mixture causing much more efficient hydrolysis by the inorganic fiber hydrolyzing agent resulting in faster reaction times using lower amount of reactants. Another related advantage is that reaction time (i.e., the residence within the mixer) can be very short compared to a batch process. In typical embodiments the period of residence in the mixer can be less than five minutes. In some practices the residence time can be as short as 1 to 5 seconds, typically on the order of 2 to 4 seconds.

The products provided herein differ from those in U.S. Pat. No. 5,693,296 in that the present products are a dried mixture combination of both soluble and insolubilized fiber components formed into pellets for animal feed.

US patent application number 2004/0147738A1 describes alkali treatment of fiber containing materials for efficient extraction of a soluble fiber fraction form the materials but utilizes a greater content of CaO to obtain the desired result. In contrast, the combination provided for in the present embodiment reduces the CaO use to less than 10% thereby reducing chemical demand. Moreover, while the 2004/0147738A1 is concerned with separating the solubilized components from the mixture, the present teaching utilizes the combination of solubilized and insolubilized components as whole in a dried animal feed.

U.S. Pat. Nos. 4,600,590 and 5,037,663, describe a method of treating cellulose-containing materials to increase chemical and biological reactivity of cellulose. In those cases, the cellulose is contacted, in a pressure vessel, with a volatile liquid swelling agent having a vapor pressure greater than atmospheric at ambient temperatures, such as ammonia. However the method discloses use of pressures over 165 pounds per square inch in a large scale pressure vessel. In addition, gaseous ammonia is used which may create problems in terms of safety of the process when operated on a large scale.

The foregoing prior art is predominantly directed towards producing a product for human nutrition. One of the teachings of this disclosure is the use of dried feeds prepared as such for animal nutrition. None of the references use chemically pretreated, and then enzymatically hydrolyzed fibers for animal feed in a mixture of soluble and insoluble fiber fractions where the soluble dietary fiber is in excess of 50%.

The feed materials described herein begin with biomass fiber sources containing low- or mid-digestible fiber. Various methods may be used to pretreat the lignocellulosic materials, including alkaline treatments, acid treatments, oxidizing treatments, heat treatments, mechanical treatments, and enzyme treatments on many different types of materials, including soybean hulls, soybean straw, wheat straw, wheat hulls, wheat midds, wheat starch, corn stover, corn cobs, barley straw, barley hulls, barley mill waste, oat hulls, oat straw, cottonseed, cotton gin waste, rice hulls, rice straw, sugar cane bagasse, sugar beet pulp, prairie grass, orchardgrass, fescue, switchgrass, alfalfa, other forage crop fibers, etc. Distillers dried grains with or without solubles may also be used.

The biomass containing fiber source is first pretreated using a process that includes a chemical, physical, or thermal treatment or a combination of the three treatments, typified by treatment with an inorganic fiber hydrolyzing agent. These pretreatments increase the surface area, decrease the crystallinity, and decrease the degree of polymerization of the polysaccharides or lignin in the fiber source, and/or extract some of the lignin from the biomass feed source. The pretreatments described herein increase the susceptibility of the fiber to further enzymatic hydrolysis, either in-vitro, by further digestion with fiber degrading enzymes or in-vivo, when directly fed to a ruminant.

One important aspect of the methods provided herein is that they provide a method of rapidly reacting edible fiber with chemicals or enzymes or both to increase the proportion of soluble fiber in the edible fiber. The increase in soluble fiber leads to a subsequent improvement in the digestion of edible fiber by the animal. Another surprising discovery is that the treatment methods improve solubility and digestibility of edible fiber while maintaining a significant capacity for liquid retention by the treated fiber.

A thermo-chemical treatment may partially hydrolyze and/or decrystallize the hemi cellulose, cellulose, and lignin fractions of fiber containing materials not ordinarily used for high energy animal feeds, such as stover/straw/hulls a thermo chemical pretreatment decreases the crystallinity of the cellulose and renders it more bio-available, and will also degrade the hemi cellulose portions to soluble oligosaccharide fractions. The partial hydrolysis of the cellulosic portion will cause the cellulose to become more susceptible to degradation by the microbial cellulases in ruminants.

Chemical treatments utilizing acids, organosolvs, or bases can also improve carbohydrate digestibility through the hydrolysis of backbone sugar O-glycosidic linkages, release of side chain substituents, separation of hemi cellulose from lignin, or solubilization of hemi cellulose and lignin. In certain embodiments, after such pretreatment, the entire biomass, including the reactants, can be dried and typically shaped into a feed pellet directly useful for feeding ruminants in particular. Chemical treatments may involve the use of calcium oxide (CaO) in combination with grinding, heat, and pressure to increase the rate of reaction and extent of edible fiber conversion to soluble fiber beyond that which would be anticipated. For this invention Calcium Hydroxide may be substituted for Calcium Oxide. Those skilled in the art will appreciate that in the presence of moisture, Calcium Oxide will react with water to produce Calcium Hydroxide.

In preferred embodiments, the fiber containing material is also subject to enzymatic treatments utilizing fiber degrading enzymes, including but not limited to, cellulases, hemicellulases esterases phytases, laccases, peroxidases, and proteases to further decrease polymer crystallinity thus improve bio-availability. Peroxidases are particularly useful when the inorganic fiber hydrolyzing agent includes a peroxide.

The wetted biomass/enzyme mixture is typically incubated at pH 2-7 and a temperature from ambient temperature to 100° C. More typical temperature ranges are from 50-80° C. The enzyme/biomass mixture could be incubated at those conditions for between 1 to 100 hours. In certain practices the enzyme may be included with fiber source in twin screw mixer using the continuous process In such a case the enzyme reaction time may include a first portion of time of reaction in the mixer with an optional second period of reaction time after exiting the extruder.

The enzymatic treatment is preferably conducted after the inorganic hydrolysis, which is then a pretreatment step. However, the enzymatic hydrolysis can occur before or simultaneously with the inorganic hydrolysis. As may be noted from the Examples some enzyme mixtures are inhibited by calcium oxide, which a preferred inorganic hydrolyzing agent. In such cases where calcium oxide is used, the enzymatic hydrolysis should be done before the inorganic hydrolysis. In any case, the two-step process causes enhanced degradation of the biomass to form a product with enhanced digestibility compared with products prepared using only inorganic hydrolysis or only enzymatic hydrolysis.

The examples below are only representative of some aspects of this disclosure. It will be understood by those skilled in the art that processes as set forth in the specification can be practiced with a variety of alterations with the benefit of the disclosure. These examples and the procedures used therein should not be interpreted as limiting the invention in any way not explicitly stated in the claims.

### Example 1

### Treatment of Biomass Fiber Sources

Wheat straw, rice hulls, rice straw, corn stover and oat hulls were ground in a Fitz Mill Comminutor (Elmhurst, Ill.) to a uniform size through a ½″ screen. Distiller's dried grains with solubles, corn gluten feed, and soy hulls were also tested, but not ground. The ground biomass fibers were treated with thermo chemical treatments to increase biomass digestibility. Two treatments have been conducted, the first treatment with 10 w/w % calcium hydroxide and the second treatment with 2 w/w % ammonium hydroxide.

In the treatments with 10% calcium hydroxide, 1 kg (as-is basis) of each of the ½″ ground biomass fibers were mixed with 100 grams of calcium hydroxide in a tumbler reactor and heated with direct steam injection to 145° C. for 30 minutes. The biomass fiber mixtures were removed from the reactor and the masses were recorded. In the treatment with 2% ammonium hydroxide, 1 kg (as-is basis) of each of the ½″ ground biomass fibers were mixed with 100 mL of 20% ammonium hydroxide in a tumbler reactor and heated with direct steam injection to 145° C. for 30 minutes. The biomass fiber mixtures were removed from the reactor and the masses were recorded. Table 1 details the total amount of solubilization of the biomass fiber sample by the treatment.

TABLE 1
Biomass digestibility experiment results

| | | Ammonia Treatment | | | Calcium Hydroxide Treatment | | |
|---|---|---|---|---|---|---|---|
| | % Biomass | Added | Dry Solids | % | Added | Dry Solids | % |
| | Dry Solids | Mass (kg) | in Liquid, % | Solubilized | Mass (kg) | in Liquid, % | Solubilized |
| Corn Stover | 88.10 | 5.500 | 2.08 | 13.0% | 5.665 | 3.00 | 19.3% |
| Wheat Straw | 89.40 | 5.170 | 1.75 | 10.1% | 4.900 | 3.39 | 18.6% |
| Oat Hulls | 86.65 | 5.130 | 1.25 | 7.4% | 5.595 | 3.15 | 20.3% |
| Soy Hulls | 93.00 | 5.260 | 4.41 | 24.9% | 5.260 | 5.25 | 29.7% |
| Rice Straw | 90.95 | 5.750 | 2.40 | 15.2% | 3.870 | 4.95 | 21.1% |
| Rice Hulls | 91.18 | 4.880 | 1.50 | 8.0% | 5.740 | 2.09 | 13.2% |
| DDGS | 91.65 | 7.070 | 5.45 | 42.0% | 5.420 | 8.35 | 49.4% |
| CGF | 89.35 | 6.170 | 6.00 | 41.4% | 5.205 | 7.40 | 43.1% |

The treated biomass fiber samples were tested for determination of ruminal digestibility in fistulated cattle. Samples were analyzed for 24-hour in situ dry matter (DM) and neutral detergent fiber (NDF) disappearance as well as typical chemical constituents (crude protein; CP), NDF, acid detergent fiber (ADF), acid detergent insoluble nitrogen (ADIN), neutral detergent insoluble nitrogen (NDIN), and ash. Samples were fermented in duplicate using a minimum of two animals and analysis of DM and NDF obtained for individual in situ bags as replication. Table 2 lists the composition of the fibers before and after pretreatment, and Table 3 details the change in digestibility of the fibers pre- and post-treatment.

TABLE 2
Effect of ammoniation or Calcium Hydroxide processing on sample chemistry

| | NDF, % | | | | ADF, % | | | |
|---|---|---|---|---|---|---|---|---|
| Ingredient | Native | Ca(OH)₂ | NH₃ | Average | Native | Ca(OH)₂ | NH₃ | Average |
| CGF | 30.1 | 22.4 | 44.0 | 32.2 | 11.7 | 19.3 | 21.3 | 17.4 |
| Corn Stover | 75.7 | 60.7 | 69.0 | 68.5 | 50.3 | 55.1 | 49.6 | 51.7 |
| DDGS | 33.2 | 26.7 | 47.3 | 35.7 | 20.8 | 21.9 | 28.3 | 23.7 |
| Oat Hulls | 76.5 | 57.9 | 83.9 | 72.8 | 45.1 | 49.2 | 53.3 | 49.2 |
| Rice Hulls | 66.1 | 60.9 | 71.5 | 61.2 | 66.3 | 65.4 | 72.5 | 68.1 |
| Rice Straw | 62.0 | 64.1 | 55.4 | 60.5 | 52.2 | 56.6 | 46.7 | 51.8 |
| Soy Hulls | 64.5 | 64.3 | 72.8 | 67.2 | 48.8 | 59.9 | 64.6 | 57.8 |
| Wheat Straw | 68.7 | 72.3 | 61.0 | 67.3 | 53.0 | 54.3 | 52.8 | 53.4 |
| Average | 61.1 | 54.7 | 64.4 | | 44.1 | 48.2 | 49.5 | |
| | HemiCellulose¹, % | | | | ADI-CP, % | | | |
| Ingredient | Native | Ca(OH)₂ | NH₃ | Average | Native | Ca(OH)₂ | NH₃ | Average |
| CGF | 18.4 | 3.1 | 22.7 | 14.7 | 1.6 | 5.4 | 4.9 | 4.0 |
| Corn Stover | 25.4 | 5.6 | 19.4 | 16.8 | 0.8 | 1.2 | 2.3 | 1.4 |
| DDGS | 12.4 | 4.8 | 19.0 | 12.1 | 6.2 | 7.9 | 12.3 | 8.8 |
| Oat Hulls | 31.4 | 8.7 | 30.6 | 23.6 | 0.3 | 0.8 | 0.8 | 0.6 |
| Rice Hulls | −0.2 | −4.5 | −1.0 | −1.9 | 0.8 | 1.1 | 1.2 | 1.0 |
| Rice Straw | 9.8 | 7.5 | 8.7 | 8.7 | 0.7 | 1.8 | 1.2 | 1.2 |
| Soy Hulls | 15.7 | 4.4 | 8.2 | 9.4 | 1.3 | 3.9 | 3.6 | 2.9 |
| Wheat Straw | 15.7 | 18.0 | 8.2 | 14.0 | 0.8 | 2.1 | 1.6 | 1.5 |
| Average | 17.0 | 6.4 | 15.0 | | 1.5 | 2.9 | 3.3 | |
| | NDI-CP, % | | | | Ash, % | | | |
| Ingredient | Native | Ca(OH)₂ | NH₃ | Average | Native | Ca(OH)₂ | NH₃ | Average |
| CGF | 4.3 | 7.3 | 6.5 | 6.0 | 7.4 | 21.2 | 8.4 | 12.3 |
| Corn Stover | 1.4 | 1.1 | 2.4 | 1.6 | 3.9 | 11.2 | 6.6 | 7.2 |
| DDGS | 4.9 | 10.3 | 16.6 | 10.6 | 4.2 | 16.9 | 4.0 | 8.4 |
| Oat Hulls | 0.8 | 0.9 | 1.1 | 0.9 | 5.8 | 11.3 | 5.9 | 7.7 |
| Rice Hulls | 0.9 | 1.3 | 1.5 | 1.2 | 17.3 | 21.6 | 18.1 | 19.0 |
| Rice Straw | 0.9 | 2.1 | 1.6 | 1.5 | 15.2 | 17.3 | 22.5 | 18.3 |
| Soy Hulls | 3.2 | 3.8 | 4.3 | 3.8 | 4.0 | 10.9 | 4.0 | 6.3 |
| Wheat Straw | 1.4 | 2.2 | 1.3 | 1.6 | 7.7 | 6.3 | 14.5 | 9.5 |
| Average | 2.1 | 3.4 | 4.1 | | 7.8 | 14.0 | 9.9 | |

¹Hemicellulose = NDF-ADF

TABLE 3
Effect of ammoniation or Calcium Hydroxide processing
on the percentage of edible fiber¹ solubilized by
microbial enzymes during ruminal incubation

| | | % of edible fiber solubilized after 48-hour | | |
|---|---|---|---|---|
| | Edible fiber | exposure to rumen microbial enzymes | | |
| | (g/100 g of | No treatment | | |
| Feed Material | feed) | (Control) | Ca(OH)₂ | NH₃ |
| Corn Gluten | 30.1 | 48.6 | 84.1 | 66.5 |
| Feed | | | | |
| Corn Stover | 75.7 | 22.9 | 44.0 | 13.8 |
| DDGS | 33.2 | 42.1 | 77.3 | 66.6 |
| Oat Hulls | 76.5 | 15.4 | 37.6 | 18.3 |
| Rice Hulls | 66.1 | 5.1 | 11.8 | 2.2 |
| Rice Straw | 62.0 | 15.5 | 35.1 | 47.7 |
| Soy Hulls | 64.5 | 51.5 | 58.4 | 34.3 |
| Wheat Straw | 68.7 | 17.2 | 18.3 | 35.2 |
| Average | 61.1 | 26.1 | 44.8 | 33.5 |

The efficacy of calcium hydroxide treatment and ammoniation was affected by sample type, but calcium hydroxide treatment was found to be more effective than ammoniation under these processing conditions. When adjusted for initial ingredient values, increased fermentability of fiber was correlated with the decrease in hemi cellulose due to treatment. Ammoniation increased NDF content of the grain by-products most likely by solubilizing non-fibrous components (i.e., starch) while not appreciably increasing ash content. NDF insoluble nitrogen was also increased for these samples, suggesting increasing association of protein with fiber in this treatment. Dry matter and NDF digestion were improved with calcium hydroxide treatment for all treatments. The effect of ammoniation on fiber digestion was variable with small improvements for several ingredients, decreased NDF digestion for rice hulls and corn stover, and substantial improvements for rice and wheat straws (numerically greater than calcium hydroxide treatment). The rumen un-degradable protein (RUP) content of treated samples was elevated for both chemical treatments, reflecting the effects of heat on rumen digestibility of protein.

These results suggest that calcium hydroxide treatment is more robust than ammoniation for improving digestibility of lignocellulosics.

### Example 2

### Enzyme Hydrolysis of Untreated or Pretreated Biomass Fibers

The thermo chemically pretreated samples from EXAMPLE 1 (10% calcium hydroxide and 2% ammonia), which were treated in a tumbler reactor, were washed with water and dried under vacuum at 80° C. for 72 hrs. The samples were pulverized with a coffee grinder. A Wiley mill was used to further grind the samples into a fine powder through a size 40 mesh. Deep well microplates were used for the enzyme hydrolysis with 50 mg samples in each well. A 2 mL sample of enzyme cocktail (0.1% w/v, enzyme mixture/water) in a 20 mM citrate buffer at pH 5.0 was measured into each well with the fiber samples. The xylanase/β-glucosidase/β-glucanase enzyme mixture included equal portions of NS-50010 (β-glucosidase, Novozymes, Franklinton, N.C.), NS-50029 (β-glucanase, Novozymes), UltraFlo L (β-glucanase, Novozymes), NS-50014 (xylanase, Novozymes), NS-50030 (xylanase, Novozymes), Multifect Xylanase (xylanase, Novozymes) and also one of four cellulase enzymes. The cellulase enzymes tested were NS-50012 (β-glucanase, Genencor, Rochester, N.Y.), NS-50013 (cellulase, Novozymes), GC220 (cellulase, Genencor) and Multifect GC (cellulase, Genencor). The microplates were placed in a 50° C. shaker at 100 rpm for 16 hrs. The enzyme/fiber mixtures were then centrifuged for 10 minutes at 2000 rpm and 1 ml of supernatant was used to test for glucose and total carbohydrates analysis.

Tables 4 and 5 show the total soluble carbohydrate and glucose released from the thermo chemical treated fiber samples after enzyme hydrolysis. The four cellulase enzymes, NS-50012, NS-50013, GC220 and Multifect GC, show differences in the digestion of the various fiber samples. GC220 and Multifect GC were found to perform better than NS-50012 and NS-50013. The enzyme hydrolysis of the thermo chemically pretreated fiber samples was superior to the enzyme hydrolysis of the untreated fibers.

TABLE 4
Total carbohydrate solubilized by enzyme treatment

| Carbohydrates g/L | | | | | |
|---|---|---|---|---|---|
| | cellulase | NS-50012 | NS-50013 | GC220 | Multifect GC |
| Control | corn stover | 0.22 | 1.51 | 2.46 | 2.78 |
| | oat hulls | 1.18 | 1.35 | 2.88 | 0.68 |
| | rice straw | 2.26 | 2.78 | 1.75 | 1.59 |
| | wheat straw | 1.10 | 2.39 | 3.90 | 2.73 |
| | rice hulls | 1.36 | 0.26 | 0.07 | 0.13 |
| | soy hulls | 5.44 | 3.72 | 8.14 | 4.89 |
| NH₃ | corn stover | 0.59 | 4.61 | 9.06 | 6.99 |
| Treated | oat hulls | 0.97 | 2.41 | 4.69 | 4.07 |
| | rice straw | 0.95 | 5.32 | 9.61 | 8.37 |
| | wheat straw | 0.89 | 3.98 | 6.68 | 6.69 |
| | rice hulls | 0.34 | 0.59 | 0.51 | 0.08 |
| | soy hulls | 2.20 | 5.63 | 12.77 | 8.47 |
| Ca(OH)₂ | corn stover | 2.63 | 5.58 | 6.8 | 5.05 |
| Treated | oat hulls | 0.00 | 0.16 | 1.21 | 0.80 |
| | rice straw | 0.24 | 6.72 | 10.63 | 9.7 |
| | wheat straw | 1.54 | 5.29 | 5.37 | 3.56 |
| | rice hulls | 0.50 | 0.20 | 0.57 | 5.00 |
| | soy hulls | 2.51 | 5.36 | 5.96 | 8.07 |

TABLE 5
Glucose solubilized by enzyme treatment

| Glucose g/L | | | | | |
|---|---|---|---|---|---|
| | cellulase | NS-50012 | NS-50013 | GC220 | Multifect GC |
| Control | corn stover | 0.05 | 0.91 | 0.89 | 1.02 |
| | oat hulls | 0.02 | 0.13 | 1.18 | 0.39 |
| | rice straw | 0.57 | 0.53 | 0.5 | 1.02 |
| | wheat straw | 0.00 | 0.98 | 0.93 | 0.35 |
| | rice hulls | 0.84 | 0.49 | 0.31 | 0.33 |
| | soy hulls | 0.56 | 0.93 | 1.65 | 1.05 |
| NH₃ | corn stover | 0.54 | 2.33 | 2.43 | 3.32 |
| treated | oat hulls | 0.47 | 1.42 | 2.08 | 1.42 |
| | rice straw | 0.00 | 1.27 | 2.29 | 2.87 |
| | wheat straw | 0.33 | 1.25 | 2.18 | 1.72 |
| | rice hulls | 0.08 | 0.05 | 0.33 | 0.28 |
| | soy hulls | 0.47 | 1.72 | 2.95 | 2.24 |
| Ca(OH)₂ | corn stover | 0.00 | 0.23 | 0.46 | 0.27 |
| treated | oat hulls | 0.00 | 0.31 | 0.37 | 0.22 |
| | rice straw | 0.16 | 1.4 | 1.52 | 2.68 |
| | wheat straw | 0.00 | 0.51 | 0.36 | 0.59 |
| | rice hulls | 0.00 | 0.12 | 0.28 | 0.54 |
| | soy hulls | 0.43 | 2.11 | 1.49 | 2.59 |

### Example 3

### Evaluation of Enzyme Treatments

To evaluate the amount of carbohydrate that could be released by the enzyme without feed back inhibition, 250 mg samples were place in a 15 mL tube with 10 mL of enzyme mix (20 mM citrate, pH 5.0, 0.1% cellulase mix). The fiber/enzyme mixtures were placed into a 50° C. water bath and the supernatant was separated every 24 hours and analyzed. Then 8 mL of fresh enzyme mix was added to the biomass samples and the enzyme hydrolysis continued for another 24 hrs. The enzyme hydrolysis was continued for 5 days. Since cellulase is inhibited by the products of the reaction, removing the products from the fiber/enzyme mixture each day was found eliminate the feedback inhibition. The resulting concentrations of glucose and soluble carbohydrate in the products represent the total amount of biomass that is accessible by the enzyme mix after thermo chemical treatment.

From Table 6, it can be determined that more than 80% of the biomass could be released by enzyme hydrolysis with glucose accounting for most of the released soluble carbohydrate. Considerable variation in carbohydrate release from fiber samples of different treatments and different sources was also detected. The longer the enzyme hydrolysis continued, the lower the amount of carbohydrates released (Days 4 or 5).

TABLE 6
Summary of continuous enzyme treatment experiments

| | | | | | | | Total (mg) | |
|---|---|---|---|---|---|---|---|---|
| Biomass and | Days of Enzyme Hydrolysis | | | | | | sugars | % of |
| Treatments | Day 1 | Day 2 | Day 3 | Day 4 | Day 5 | Average | solubilized | 250 mg |

Glucose (g/L)

| | | | | | | | | |
|---|---|---|---|---|---|---|---|---|
| Rice straw | 2.79 | 2.08 | 0.49 | 0.45 | 0.36 | 1.23 | 41.6 | 16.638 |
| Soy hulls | 3.93 | 3.61 | 3.36 | 2.99 | 1.05 | 2.99 | 106.8 | 42.726 |
| Rice straw | 4.67 | 2.21 | 1.14 | 0.88 | 0.45 | 1.87 | 61.9 | 24.764 |
| (NH₃) | | | | | | | | |
| Soy hulls | 4.13 | 5.16 | 3.77 | 3.73 | 1.33 | 3.62 | 131.0 | 52.386 |
| (NH₃) | | | | | | | | |
| Rice straw | 3.64 | 2.68 | 1.35 | 0.93 | 0.27 | 1.77 | 59.9 | 23.968 |
| (Ca(OH)₂) | | | | | | | | |
| Soy hulls | 3.49 | 4.87 | 3.77 | 3.58 | 1.43 | 3.43 | 125.2 | 50.058 |
| (Ca(OH)₂) | | | | | | | | |

Total Carbohydrate (g/L)

| | | | | | | | | |
|---|---|---|---|---|---|---|---|---|
| Rice straw | 4.08 | 2.29 | 1.41 | 1.36 | 1.37 | 2.1 | 74.2 | 29.66 |
| Soy hulls | 5.49 | 5.45 | 4.94 | 3.83 | 1.74 | 4.29 | 154.2 | 61.66 |
| Rice straw | 6.58 | 3.62 | 2.11 | 1.59 | 0.87 | 2.95 | 99.7 | 39.88 |
| (NH₃) | | | | | | | | |
| Soy hulls | 8.02 | 7.38 | 5.68 | 5.43 | 2.34 | 5.77 | 206.22 | 82.49 |
| (NH₃) | | | | | | | | |
| Rice straw | 8.91 | 4.55 | 2.23 | 1.68 | 0.81 | 3.64 | 120.55 | 48.22 |
| (Ca(OH)₂) | | | | | | | | |
| Soy hulls | 7.23 | 6.71 | 5.15 | 4.79 | 2.16 | 5.21 | 186.18 | 74.47 |
| (Ca(OH)₂) | | | | | | | | |

### Example 4

### Mechanical Processing of Wheat Straw and Corn Stover

A mechanical twin screw extruder was used to provide more effective chemical or enzymatic treatment of a plant material such as wheat straw or corn stover. In this example a Readco type processor available from READCO KURIMOTO, LLC. (York, Pa.) was used to provide mechanical shear and temperature to enhance hydrolysis of the plant material. This processing device can be ideal for application of ammonia or other chemicals to biomass feed-stocks.

Several treatments to increase the digestibility of corn stover and wheat straw biomasses were evaluated and they are described in Table 7. One of the advantages of a mechanical twin screw extruder is that the amount of chemical added could be less as the processor distributes the chemicals more effectively than conventional mixing equipment.

TABLE 7
Readco Processing of Wheat Straw and Corn Stover

| | | Amount added as | Total |
|---|---|---|---|
| Treatment # | Treatment | a % of Dry Matter | Moisture, % |
| 1 | Anhydrous NH₃ | 3.0 | 35 |
| 2 | Anhydrous NH₃ | 6.0 | 35 |
| 3 | CaO | 2.5 | 35 |
| 4 | CaO | 5.0 | 35 |
| 5 | CaO | 10.0 | 35 |
| 6 | NaOH and H₂O₂ | 5.0 and 3.0 | 50 |
| 7 | NaOH and H₂O₂ | 2.5 and 1.5 | 50 |
| 8 | NaClO | 200 ppm | 30 |
| 9 | NaClO | 100 ppm | 30 |

Corn stover and wheat straw were processed in the Readco Processor to have a mean particle size of 0.5-5 mm, preferably 0.5-3 mm. The processor was set for all treatments to have a 2-minute retention time for chemical treatment addition, agitation, and particle size reduction. All of the chemical additions except for CaO were performed with no added heat; however, heat was generated by the chemical reactions, which were exothermic. The CaO treatments were applied at 145° C. to facilitate the reaction. The temperature of all reactions was recorded.

Samples from all treatments were analyzed for gas production and fermented in duplicate for 24 and 48 hours in a rumen-simulation in vitro assay. Gas volume, DM, and NDF digestion were measured. The effects of treatment on fiber content, non-fiber nutrient content and simulated ruminal in vitro NDF digestion are presented in Table 8. The application of CaO in the Readco processor generally had the largest effect on digestion criteria. Most of the improvement occurred with 5% addition with incremental improvement observed for 10% inclusion. The NaClO treatments had a noticeable effect on improving the hemi-cellulose fraction, but not as much of an effect on NDF disappearance and total non-fiber nutrient content of biomasses. The combination of NaOH and H₂O₂ worked especially well when wheat straw was the substrate. This study demonstrated that certain treatments work well in combination when applied using the Readco processor. Selected treatments that proved optimal in this study included 5% CaO and 2.5% NaClO with 35% moisture for corn stover and wheat straw, 5% NaOH and 2.5% NaClO with 35% moisture for corn stover and wheat straw, and 2.5% NaOH and 1.5% H₂O₂ with 35% moisture for wheat straw.

TABLE 8
Effects of chemical treatment on edible fiber content
and solubilization of edible fiber¹ by microbial
enzymes during 48-Hour ruminal incubation

| | | Edible fiber, | Edible fiber |
|---|---|---|---|
| Feed | | g/100 g of | solubilized, % of |
| Material | Treatment | dry matter | total edible fiber |
| Corn stover | 3% NH3 | 79.3 | 55.2 |
| Corn stover | 6% NH3 | 83.0 | 55.2 |
| Corn stover | 2.5% CaO | 74.5 | 61.4 |
| Corn stover | 5% CaO | 59.6 | 68.7 |
| Corn stover | 10% CaO | 55.8 | 70.1 |
| Corn stover | NaOH/H2O2 5/2.5% | 70.2 | 70.0 |
| Corn stover | NaOH/H2O2 2.5/1.5% | 81.3 | 59.1 |
| Corn stover | NaClO 200 ppm | 75.2 | 54.1 |
| Corn stover | NaClO 100 ppm | 79.7 | 49.1 |
| Corn stover | 5% NaOH 2.5% H2O2 + | 75.1 | 64.9 |
| | Pelleting | | |
| Corn stover | NaClO Corn stover + | 63.1 | 55.6 |
| | Molasses | | |
| Wheat straw | 3% NH3 | 79.8 | 53.7 |
| Wheat straw | 6% NH3 | 78.3 | 52.6 |
| Wheat straw | 2.5% CaO | 67.3 | 58.0 |
| Wheat straw | 5% CaO | 59.1 | 58.0 |
| Wheat straw | 10% CaO | 54.0 | 61.2 |
| Wheat straw | NaOH/H2O2 5/2.5% | 56.4 | 94.7 |
| Wheat straw | NaOH/H2O2 2.5/1.5% | 70.1 | 74.1 |
| Wheat straw | NaClO 200 ppm | 78.6 | 47.0 |
| Wheat straw | NaClO 100 ppm | 79.7 | 51.6 |
| Wheat straw | 5% NaOH 2.5% H2O2 + | 73.5 | 67.3 |
| | Pelleting | | |

### Example 5

### Enzymatic Hydrolysis of Mechanically Treated Samples

Select samples from the Readco thermo chemical treatment experiments on wheat straw and corn stover were obtained and enzymatically hydrolyzed. The samples treated are shown in Table 9. The biomass fiber sample preparation method was the same as described previously. A 50 mg sample of the ground biomass fiber sample was placed into a microwell, and 2 mL of a 20 mM citrate buffer at pH 5.0 containing 0.1% enzymes (R-glucanase and xylanase). 2 mL of the test cellulase was also added to the mixture. The microwell titer plate was sealed and placed into a 50° C. shaker for 24 hours. The mixture was then centrifuged for 10 minutes at 2000 RPM, and a 1 mL sample was removed for analysis. The sample was analyzed for glucose by an YSI Biochemistry Analyzer and for total carbohydrate by the colorimetric Dubois modified phenol-sulfuric acid method.

Table 9 shows that, under the conditions tested, GC220 is the most effective cellulase for wheat straw and corn stover. The calcium oxide treatments rendered all enzymes ineffective, most likely by inactivation. The ammoniation of either wheat straw or corn stover was slightly effective for enhancing the efficacy of enzyme hydrolysis. This is true for the bleach treatment of wheat straw, also. The most effective treatment coupled with enzyme hydrolysis proved to be sodium hydroxide with or without hydrogen peroxide addition.

TABLE 9
Results of enzyme hydrolysis of pre-treated biomass fibers

| | Glucose (g/L) | | | Total Carbohydrate (g/L) | | |
|---|---|---|---|---|---|---|
| | Celluclast | GC220 | MultifectGC | Celluclast | GC220 | MultifectGC |
| Wheat Straw | 0.80 | 1.1 | 1.09 | 1.04 | 2.70 | 2.65 |
| NH₃ 3% | 1.50 | 1.55 | 1.64 | 2.52 | 4.82 | 4.97 |
| NH₃ 6% | 1.30 | 1.62 | 1.61 | 1.64 | 4.84 | 4.32 |
| CaO 2.5% | 0.09 | 0.07 | 0.06 | 0.49 | 2.08 | 1.71 |
| CaO 5% | 0.04 | 0.01 | 0.00 | 0.00 | 1.31 | 1.30 |
| NaOH 5%, H₂O₂ | 1.96 | 2.6 | 1.78 | 8.87 | 12.40 | 11.08 |
| 2.5% | | | | | | |
| NaOH 2.5%, | 2.04 | 2.76 | 1.96 | 7.29 | 10.28 | 8.10 |
| H₂O₂ 1.5% | | | | | | |
| NaClO 100 ppm | 1.43 | 1.49 | 1.37 | 3.90 | 4.49 | 3.71 |
| CaO 10% | 0.26 | 0.12 | 0.24 | 0.58 | 1.01 | 0.73 |
| Corn Stover | 1.66 | 2.05 | 1.87 | 4.46 | 6.28 | 5.72 |
| NH₃ 3% | 1.34 | 1.34 | 1.17 | 3.67 | 4.29 | 4.19 |
| CaO 5% | 0.09 | 0.14 | 0.07 | 2.23 | 3.15 | 2.70 |
| NaOH 5% | 2.51 | 2.55 | 2.10 | 10.68 | 11.31 | 10.45 |
| NaOH 5%, H₂O₂ | 2.32 | 2.37 | 1.96 | 7.97 | 8.71 | 7.46 |
| 2.5% | | | | | | |
| CaO 10% | 0.26 | 0.06 | 0.22 | 1.31 | 1.45 | 1.76 |

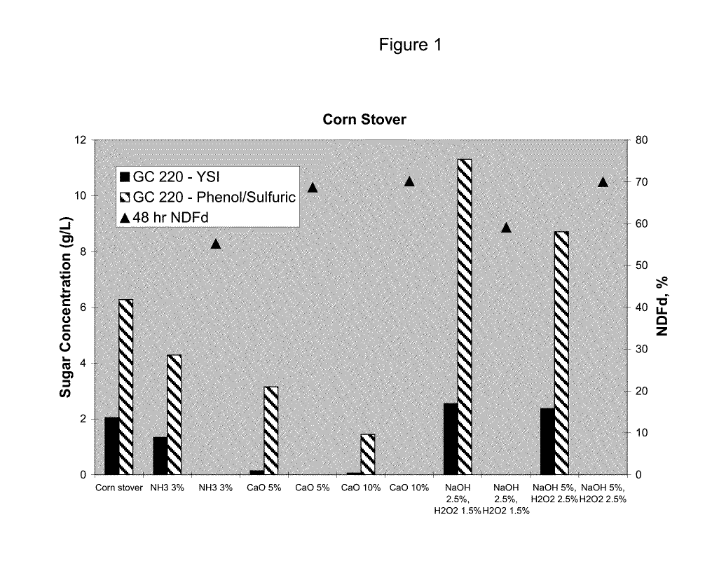

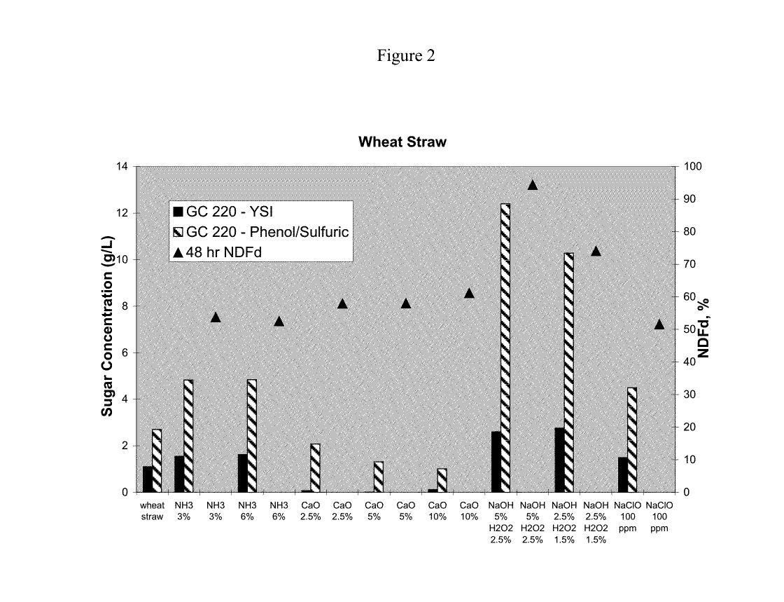

The samples from the Readco treatments were analyzed by ADM Animal Nutrition (Decatur, Ind.) for in vitro digestion. The samples were evaluated in the gas-production system with rumen fluid. At the end of the fermentation, 48-hour NDF digestion was measured. The results are shown in FIGS. 1 and 2 alongside the enzyme digestibilities. FIG. 1 compares the in vitro 48-hour NDF digestibility versus enzyme digestibility for treated samples of corn stover. This figure shows no correlation between the two results. FIG. 2 compares the in vitro 48-hour NDF digestibility versus enzyme digestibility for treated samples of wheat straw. The calcium seems to inactivate the cell-free enzymes; however, the rumen fluid treatment shows no depression of digestibility. Microbial enzymes present in rumen fluid likely are less sensitive to excess calcium, whereas cell-free enzymes may be more sensitive to high concentrations of calcium as occurred with calcium oxide treatments.

Another set of samples treated with the enzymes included three corn fiber samples. The first sample was native corn fiber, the second sample was thermo chemically hydrolyzed corn fiber and the third sample was solvent extracted, thermo chemically hydrolyzed corn fiber. The enzyme hydrolysis proceeded as detailed above, with 50 mg of samples mixed with 2 mL of 20 mM citrate buffer containing 0.1% enzyme mixture. Several cellulases were tested for efficacy regarding carbohydrate solubilization of corn fiber. The samples were also characterized by in vitro fiber digestion. The results are shown in Table 10. The extracted fiber is much more digestible by in vitro digestion methods, which also correlates with what is observed by enzymatic hydrolysis

TABLE 10
Digestibilities of corn fiber by enzymatic hydrolysis
in comparison to simulated rumen in vitro digestion

| Glucose (g/L) | | | | | | | In vitro |
|---|---|---|---|---|---|---|---|
| cellulases | celluclast | 28074 | 28076 | GC | GC220 | ultraflo | DMD % |
| corn fiber | 0.88 | 1.00 | 0.96 | 0.96 | 1.37 | 0.63 | 55.8 |
| treated corn fiber | 1.61 | 3.41 | 1.96 | 2.16 | 2.30 | 0.81 | |
| extracted | 1.68 | 3.55 | 1.71 | 1.94 | 3.32 | 0.87 | 95.9 |

Soluble carbohydrates (g/L) by phenol-sulfuric methods

| | | | | | | |
|---|---|---|---|---|---|---|
| corn fiber | 2.46 | 2.30 | 2.15 | 2.83 | 3.37 | 1.44 |
| treated corn fiber | 4.30 | 6.67 | 4.87 | 5.71 | 5.66 | 2.59 |
| Extracted | 4.33 | 7.09 | 4.24 | 5.20 | 7.01 | 2.46 |

### Example 6

### Feed Manufacturing Testing of Thermo Chemically Hydrolyzed, Extracted Corn Fiber Residue—Comparison to Native Corn Fiber

In an alternate embodiment of this teaching a rotating reactor may be employed to accomplish hydrolysis. Hydrolyzed, extracted corn fiber may be produced, for instance, by obtaining corn fiber at moisture level of between about 50% to about 70%, then adding water if needed until the moisture level is about 70%. The 70% moisture corn fiber is placed in a sealed, rotating reactor. The reactor is then heated, for instance by using steam or indirectly by hot oil, to a temperature of between about 138° C. to about 150° C. That temperature is maintained for about 30 minutes to about one hour. The reactor is then depressurized (if steam is used), and the corn fiber is dewatered. This dewatering removes an oligosaccharide-containing aqueous liquid from the mixture. Optionally, the fiber may be rinsed with a liquid to further remove free sugars from the fiber. In a further optional step, the fiber may be dried to reduce moisture content. The fiber is then extracted with at least about three volumes of 80% to 100% ethanol at about 25° C. to about 75° C. for a time period of about ten minutes to about two hours. Samples of corn fiber subjected to an extraction process were subjected to testing for bulk density and liquid holding capacity. Liquid holding capacity was measured by incremental addition of liquid to known quantities of fiber and measuring hydration characteristics defined by objective and subjective criteria. Liquid holding capacity was calculated using the following equation: grams of liquid/(grams of liquid+grams of fiber)×100. Subjective measurements included observations of swelling, compaction, balling, and clumping. The results of testing are presented in Table 11. Hydrolysis and extraction processing considerably increased the bulk density of corn fiber, which presents advantages for handling and transportation of fibers in the feed manufacturing process. Thermo chemical hydrolysis and extraction diminished to some extent the liquid holding capacity of the fiber with the degree of liquid absorption dependent on the nature of liquid applied. The results of this study demonstrated that processed corn fiber had greater bulk density with only a slight reduction in liquid holding capacity compared with native corn fiber.

TABLE 11
Feed manufacturing characteristics of hydrolyzed and extracted corn fiber

| | | LHC¹ | LHC at 24 hours | | | | |
|---|---|---|---|---|---|---|---|
| | Bulk | Initial | | | Corn | | Threonine |
| | density, | observation | | Mineral | steep | | fermentation |
| | lb/ft³ | Water | Water | oil | liquor | Glycerin | liquor |
| Corn Fiber | 7.2 | 71 | 75 | 67 | 60 | 60 | 67 |
| Hydrolyzed | 12.1 | 56 | 60 | 43 | 56 | 43 | 50 |
| Corn Fiber | | | | | | | |
| Hydrolyzed | 18.5 | 60 | 60 | n.m. | n.m. | n.m. | n.m. |
| and Extracted | | | | | | | |
| Corn Fiber | | | | | | | |

¹Liquid Holding Capacity. Calculated using swelling as the measurement criterion with numeric value assigned using the equation: grams of liquid/(grams of liquid + grams of fiber) × 100
n.m. = not measured due to insufficient material for testing.

### Example 7

### Enzymatic Hydrolysis of Biomass Followed by Thermo chemical Hydrolysis

The biomass residues (corn stover, wheat straw, soy hulls, corn fiber, etc.) can be treated by adding water to the biomass to increase the water content to 25-85% moisture, and adding a fiber-degrading enzyme blend. The enzyme blend could include hemicellulases, cellulases, starch-degrading enzymes, and proteases. The wetted biomass/enzyme mixture could then be incubated at pH 2-7 and a temperature from ambient temperature to 100° C. The enzyme/biomass mixture could be incubated at those conditions for between 1 to 100 hours. In another aspect of this example the pH could be between 4.0 to 6.0, temperature of 40° C. to 70° C. and incubation time of 24 to 72 hours may be used

After the enzyme incubation, the mixture could be thermochemically hydrolyzed, after an optional drying step, in a READCO type system with the presence of chemical agents mentioned previously. This two-step process would cause further degradation of the biomass and allow for enhanced digestibility similar to the processes exemplified herein before.

Patents, patent applications, publications, scientific articles, books, web sites, and other documents and materials referenced or mentioned herein are indicative of the levels of skill of those skilled in the art to which the inventions pertain. Each such referenced document and material is hereby incorporated by reference to the same extent as if it had been incorporated by reference in its entirety individually or set forth or reprinted herein in its entirety. Additionally, all claims in this application, and all priority applications, including but not limited to original claims, are hereby incorporated in their entirety into, and form a part of, the written description of the invention. Applicants reserve the right to physically incorporate into this specification any and all materials and information from any such patents, applications, publications, scientific articles, web sites, electronically available information, and other referenced materials or documents. Applicants reserve the right to physically incorporate into any part of this document, including any part of the written description, and the claims referred to above including but not limited to any original claims.

The inventions have been described broadly and generically herein. In addition, where features or aspects of an invention are described in terms of a Markush group, the invention shall be understood thereby to be described in terms of each and every, and any, individual member or subgroup of members of the Markush group.

As used herein and in the appended claims, the singular forms “a,” “an,” and “the” include plural reference unless the context clearly dictates otherwise. It shall be understood that, although the present invention has been specifically disclosed by preferred embodiments and optional features, modifications and variations of the inventions embodied therein or herein disclosed can be resorted to by those skilled in the art, and such modifications and variations are considered to be within the scope of the inventions disclosed and claimed herein.

Specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. Where examples are given, the description shall be construed to include but not to be limited to only those examples. It will be readily apparent to one skilled in the art that varying substitutions and modifications may be made to the invention disclosed herein without departing from the scope and spirit of the invention, and from the description of the inventions, including those illustratively set forth herein, it is manifest that various modifications and equivalents can be used to implement the concepts of the present invention without departing from its scope. A person of ordinary skill in the art will recognize that changes can be made in form and detail without departing from the spirit and the scope of the invention. The described embodiments are to be considered in all respects as illustrative and not restrictive. Thus, for example, additional embodiments are within the scope of the invention and within the following claims.

We claim:

1. A process for making an animal feed comprising:
contacting an edible fiber source in a mixture with an inorganic fiber hydrolyzing agent at a pressure of at least 10 psig and a temperature of at least 75° C. for a time sufficient to solubilize at least 10% of carbohydrates from lignocellulosic material in the edible fiber source; and
drying the contacted edible fiber source to form a dried mixture having an insoluble fiber fraction and a soluble carbohydrate fraction derived from a common edible fiber source.

2. The process of claim 1 wherein the mixture inclusive of the edible fiber source has a moisture content of 40% or less during the contacting.

3. The process of claim 1 wherein a percentage of soluble carbohydrates in the dried mixture is at least 45% wt/wt of the total carbohydrates contributed by the insoluble fiber fraction and soluble carbohydrate fraction.

4. The process of claim 1 wherein contacting the edible fiber source with the inorganic fiber hydrolyzing agent occurs in a continuous process in a mixing device having at least one rotating member that shears the edible fiber and wherein the pressure is about 14 psig to about 50 psig, the temperature is about 100° C. to 110° C., and the time is between about 1 second to less than 5 minutes.

5. The process of claim 1 wherein the inorganic fiber hydrolyzing agent is at least one agent selected from the group consisting of a pH modifying agent and an oxidizing agent.

6. The process of claim 1 wherein the inorganic fiber hydrolyzing agent is selected from the group consisting of calcium oxide, sodium hydroxide potassium hydroxide, hypochlorite, ammonia, and hydrogen peroxide, with the proviso that if ammonia is used, hydrogen peroxide is not also used.

7. The process of claim 1 wherein the edible fiber source includes at least one member selected from a the group consisting of switch grass, corn fiber, soy fiber, soy hulls, cocoa hulls, corn cobs, corn husks, corn stove, wheat straw, wheat chaff, distiller dried grains, distillers dried grains with solubles, barley straw, rice straw, flax hulls, soy meal, corn meal, wheat germ, corn germ, shrubs, grasses or mixtures of the same.

8. A process for making an animal feed comprising:
contacting an edible fiber source in a mixture with an inorganic fiber hydrolyzing agent in a continuous process in a mixing device having at least one rotating member that shears the edible fiber and wherein the pressure is about 14 psig to about 50 psig the temperature is about 100° C. to 110° C., and the time is between about 1 second to less than 5 minutes to solubilize a first portion of carbohydrates from lignocellulosic material in the edible fiber source;
contacting the edible fiber source with an enzyme fiber degrading agent selected from the group consisting of cellulases, hemicellulases, esterases phytases, laccases, peroxidases and proteases for a time sufficient to solubilize a second portion of carbohydrates from lignocellulosic material in the edible fiber source; and
drying the contacted edible fiber source to form a dried mixture having an insoluble fiber fraction and a soluble carbohydrate fraction derived from a common edible fiber source and wherein the soluble carbohydrate fraction is at least 45% wt/wt of the total carbohydrates contributed by the insoluble fiber fraction and soluble carbohydrate fraction.

9. The process of claim 8 wherein the insoluble fiber fraction are sheared into particles having a mean particle length of about 0.5 to about 25 mm its longest dimension.

10. The process of claim 8 wherein the inorganic fiber hydrolyzing agent is at least one agent selected from the group consisting of a pH modifying agent and an oxidizing agent.

11. The process of claim 8 wherein the inorganic fiber hydrolyzing agent is selected from the group consisting of calcium oxide, sodium hydroxide potassium hydroxide, hypochlorite, ammonia, and a peroxide, with the proviso that if the edible fiber source is contacted with the inorganic fiber hydrolyzing agent prior to contacting with the enzyme, the inorganic fiber hydrolyzing agent is not calcium oxide and further with the proviso that an enzyme of the class of peroxidase is included only if the inorganic fiber hydrolyzing agent includes a peroxides.

12. The process of claim 8 wherein the inorganic fiber hydrolyzing agent is selected from the group consisting of calcium oxide, sodium hydroxide potassium hydroxide, hypochlorite, ammonia, and hydrogen peroxide, with the proviso that if ammonia is used, hydrogen peroxide is not also used.

13. The process of claim 8 wherein the inorganic fiber hydrolyzing agent comprises calcium oxide.

14. The process of claim 8 wherein the edible fiber source includes at least one member selected from a the group consisting of switch grass, corn fiber, soy fiber, soy hulls, cocoa hulls, corn cobs, corn husks, corn stove, wheat straw, wheat chaff, distiller dry grains, distillers dry grains with solubles, barley straw, rice straw, flax hulls, soy meal, corn meal, wheat germ, corn germshrubs, grasses or mixtures of the same.

15. The process of claim 8, further including mixing a supplemental feed ingredient with the contacted edible fiber mixture prior to, or subsequent to, drying the mixture.

16. The process of claim 8 wherein the supplemental feed ingredient is supplied by a material selected from the group consisting of, corn steep liquor, vegetable/plant-based soap stocks, condensed distillers' solubles, molasses, corn syrup, fermentation solubles, fermentation liquors, distillates of fermentation liquors, amino acids, glycerin, fats, oils, and lecithin.

17. A process for making an animal feed with increased bulk density comprising:
contacting an edible fiber source in a mixture with an inorganic fiber hydrolyzing agent at a pressure of at least 10 psig and a temperature of at least 100° C. for a time sufficient to solubilize at least 45% of carbohydrates from lignocellulosic material in the edible fiber source;
dewatering the contacted mixture to separate a portion of soluble carbohydrates from an insoluble fiber fraction;
extracting the insoluble fiber fraction with ethanol to dehydrate and increase the bulk density of the insoluble fiber fraction; and
drying the insoluble fiber fraction to provide an edible fiber source having increased bulk density.

18. The method of claim 17 further including combining the separated portion of soluble carbohydrates with the dehydrated insoluble fiber fraction; and
drying the combined material to form a dried mixture having an insoluble fiber fraction and a soluble carbohydrate fraction derived from a common edible fiber source.

19. The process of claim 17, further including mixing a supplemental feed ingredient with the insoluble fiber fraction prior to drying.
